(19) United States
(12) Patent Application Publication
(10) Pub. No.: US 2025/0123807 A1
(43) Pub. Date: Apr. 17, 2025

(54) Random number generator and noise generator

(71) Applicant: NOVATEK Microelectronics Corp., Hsin-Chu (TW)

(72) Inventors: Cheng-Bin Chen, New Taipei City (TW); Tsung Chen, Keelung City (TW); Yuan-Hao Huang, Hsinchu City (TW); Yu-Hsiang Huang, Taoyuan City (TW)

(73) Assignee: NOVATEK Microelectronics Corp., Hsin-Chu (TW)

(21) Appl. No.: 18/761,342

(22) Filed: Jul. 2, 2024

Related U.S. Application Data
(60) Provisional application No. 63/544,234, filed on Oct. 16, 2023.

(51) Int. Cl. G06F 7/58

(52) U.S. Cl. CPC G06F 7/582

(57) ABSTRACT

A random number generator includes a pre-processing circuit and a chaos random number generator (CRNG). The pre-processing circuit includes a perturbation source and a control circuit, wherein the control circuit is coupled to the perturbation source. The CRNG, which is coupled to the pre-processing circuit, includes a chaos system and a post-processing circuit, wherein the post-processing circuit is coupled to the chaos system.

### CROSS REFERENCE TO RELATED APPLICATIONS

This application claims the benefit of U.S. Provisional Application No. 63/544, 234, filed on Oct. 16, 2023. The content of the application is incorporated herein by reference.

### BACKGROUND OF THE INVENTION

### 1. Field of the Invention

The present invention relates to a random number generator and noise generator, and more particularly, to a random number generator and noise generator implemented with a chaos system.

### 2. Description of the Prior Art

A true random number generator (TRNG) is a hardware random number generator, which is capable of generating non-periodic and unpredictable random numbers. There are two common types of TRNGs: a metastability-based TRNG jitter-based and TRNG. The metastability-based TRNG has a latch circuit implemented in a metastable state, which enters a stable state to generate random bits due to small variations of noises. The jitter-based TRNG applies a ring oscillator to generate random signals based on the jitter in the circuit. Both the metastability-based TRNG and jitter-based TRNG require a great amount of time to adjust parameters of the circuit, and might not be easily implemented on the field programmable gate array (FPGA). In addition, these TRNGs are analog circuits, which require a lot of time and costs to perform adjustments when transiting between different manufacturing processes.

Thus, there is a need to provide another random number generator having high randomness and high unpredictability and easily implemented in hardware circuitry.

### SUMMARY OF THE INVENTION

It is therefore an objective of the present invention to provide a novel random number generator implemented with a chaos system and a related noise generator, in order to solve the abovementioned problems.

An embodiment of the present invention discloses a random number generator, which comprises a pre-processing circuit and a chaos random number generator (CRNG). The pre-processing circuit comprises a perturbation source and a control circuit, wherein the control circuit is coupled to the perturbation source. The CRNG, which is coupled to the pre-processing circuit, comprises a chaos system and a post-processing circuit, wherein the post-processing circuit is coupled to the chaos system.

Another embodiment of the present invention discloses a noise generator, which comprises a random number generator and a noise generation circuit. The random number generator comprises a pre-processing circuit and a CRNG. The pre-processing circuit comprises a perturbation source and a control circuit, wherein the control circuit is coupled to the perturbation source. The CRNG, which is coupled to the pre-processing circuit, comprises a chaos system and a post-processing circuit, wherein the post-processing circuit is coupled to the chaos system. The noise generation circuit is coupled to the random number generator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a random number generator according to an embodiment of the present invention.

FIG. 2 illustrates an exemplary implementation of converting the chaos signal into the random signal according to an embodiment of the present invention.

FIG. 3 is a schematic diagram of the circuit structure of the modulo operation circuit.

FIG. 4 is a schematic diagram of a noise generator according to an embodiment of the present invention.

FIG. 5 illustrates the random number generator outputting the random signals to a LiDAR system.

FIG. 6 illustrates the noise generator outputting the noise signals to a LiDAR system.

FIG. 7 illustrates a detailed implementation for realizing the application of a LiDAR system.

### DETAILED DESCRIPTION

A chaos random number generator (CRNG) applies a chaos system to generate random outputs. The chaos system is a nonlinear system which generates outputs to form a disorder orbit. The chaos system is sensitive to initial conditions and has non-periodic properties. If the initial value has a small change, the chaos system will generate an entirely different orbit. This makes the outputs of the chaos system substantially random. However, the output values may still be predictable if the initial value and parameters of the CRNG are known. In addition, the behavior of the chaos system is represented by differential equations mathematically, which are difficult to be generated in hardware circuitry, and should be implemented by using some approximation method. The fourth-order Runge-Kutta (RK4) method is an example used for approximating the outputs of the chaos system. This method is complex, and thus requires high hardware costs and limits the system throughput.

The present invention applies the chaos system to implement a random number generator, to realize a CRNG having improved unpredictability. In several embodiments, the random number generator is integrated with a noise generation circuit to realize a noise generator, where the noise generation circuit may convert a series of random numbers having uniform distribution into noise signals having normal distribution.

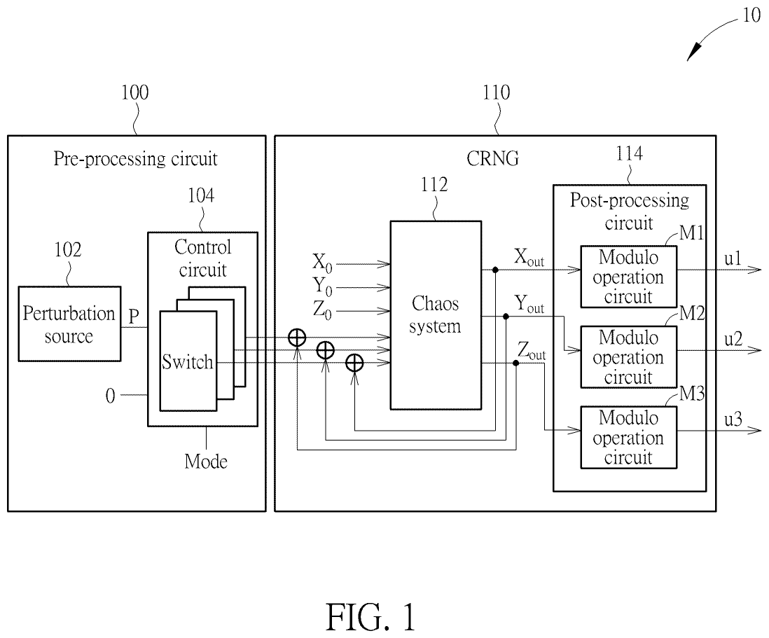

FIG. 1 is a schematic diagram of a random number generator 10 according to an embodiment of the present invention. The random number generator 10 includes a pre-processing circuit 100 and a CRNG 110, where the CRNG 110 is coupled to the pre-processing circuit 100. More specifically, the CRNG 110 is coupled to the output terminal of the pre-processing circuit 100, to receive one or more perturbation signals from the pre-processing circuit 100.

The pre-processing circuit 100 includes a perturbation source 102 and a control circuit 104. The perturbation source 102 may sample a physical random noise to generate a perturbation signal P and output the perturbation signal to the CRNG 110, where the perturbation signal P is applied to disturb the CRNG 110. The random noise may be generated from any appropriate noise source having sufficient randomness. In an exemplary embodiment, the perturbation signal P may be generated from an environmental noise. The perturbation source 102 may include an analog-to-digital converter (ADC), for sampling the environmental noise and converting the noise signal into a digital form, so that the generated perturbation signal P may become unpredictable. The unpredictable perturbation signal P may be used as the initial value or used to modify the initial value, to change the output curve of the CRNG 110. Based on the perturbation signal P, the random numbers generated by the CRNG 110 will become more unpredictable.

The control circuit 104, which is coupled to the output terminal of the perturbation source 102, may include a multiplexer or switch circuit, for controlling the output of the perturbation signal P based on the operation modes or settings of the random number generator 10. For example, the pre-processing circuit 100 may periodically or non-periodically output the perturbation signal P to the CRNG 110 based on the control of the control circuit 104. As shown in FIG. 1, the control circuit 104 includes several switch circuits, which may enable the input of the perturbation signal P in a first operation mode, and disable the input of the perturbation signal P (i.e., by receiving the signal 0) in a second operation mode.

The CRNG 110 includes a chaos system 112 and a post-processing circuit 114. As shown in FIG. 1, the chaos system 112 may receive initial values X₀, Y₀ and Z₀ and also receive the perturbation signal P from the pre-processing circuit 100 in different input channels, which means that the received perturbation signal P may serve as a factor for adjusting the iteration process of the chaos system 112, and/or may be used to modify the initial values X₀, Y₀ and Z₀ which have been received by the chaos system 112; that is, increase or decrease the initial values X₀, Y₀ and Z₀ by one step. According to the initial values X₀, Y₀ and Z₀ (with the incorporation of the perturbation signal P), the chaos system 112 may generate and output chaos signals Xₒᵤₜ, Yₒᵤₜ and Zₒᵤₜ, respectively. In another embodiment, there may be three perturbation signals output by the pre-processing circuit 100 serving as three initial values for performing iterations and generating output chaos signals. Alternatively, the perturbation signal(s) may first be combined with the initial values X₀, Y₀ and Z₀, respectively, and their combinations are received by the chaos system 112 for performing iterations and generating output chaos signals. In such a situation, the initial values X₀, Y₀ and Z₀ may become unpredictable.

The chaos system 112 may apply any appropriate algorithm to generate the chaos signals Xₒᵤₜ, Yₒᵤₜ and Zₒᵤₜ, and an example of the chaos system 112 is the Lorenz system. In this embodiment, the chaos system 112 may be a Euler-based chaos system, which uses the Euler method to solve the differential equations of the Lorenz system, which are described as follows:

$$\{ \begin{matrix}\dot{x} = σ ( y - x ) \\ \dot{y} = x ( ρ ‐ z ) ‐ y \\ \dot{z} = xy - β z\end{matrix} ;$$

where x, y and z indicate the output values of the chaos system 112 that represent a three-dimensional coordinate to form a chaos curve, and σ, ρ, β are parameters of the Lorenz system. In an embodiment, the parameters may be set to (σ, ρ, β)=(10, 28, 8/3). By using the Euler method to solve the Lorenz system, the output chaos signals will become:

$$\{ \begin{matrix}{x}_{n + 1} = x ( t ) + {\dot{x}}_{n} Δ t = {x}_{n} + 10 ( {y}_{n} - {x}_{n} ) Δ t \\ {y}_{n + 1} = y ( t ) + {\dot{y}}_{n} Δ t = {y}_{n} + ( {x}_{n} ( 28 - {z}_{n} ) - {y}_{n} ) Δ t \\ {z}_{n + 1} = z ( t ) + {\dot{z}}_{n} Δ t = {z}_{n} + ( {x}_{n} {y}_{n} - 8 / 3 {z}_{n} ) Δ t\end{matrix} .$$

Since the Euler method is applied to solve the first-order differential equations, the hardware cost may be saved as compared to the abovementioned fourth-order computation of the RK4 method. In the Euler-based chaos system 112, the overall throughput may also be improved.

Note that the Lorenz system is merely an exemplary implementation of the chaos system 112. In another embodiment, a modified Lorenz system may be applied, as described below:

$$\{ \begin{matrix}\dot{x} = σ ( y - x ) \\ \dot{y} = sign ( x ) ( ρ ‐ z ) \\ \dot{z} = ( \vert x \vert - β z )\end{matrix} .$$

The Euler method may be used to solve the differential equations of the modified Lorenz system, to be represented as:

$$\{ \begin{matrix}{x}_{n + 1} = {x}_{n} + {\dot{x}}_{n} Δ t = {x}_{n} + σ ( {y}_{n} - {x}_{n} ) Δ t \\ {y}_{n + 1} = {y}_{n} + {\dot{y}}_{n} Δ t = {y}_{n} + sign ( {x}_{n} ) ( ρ - {z}_{n} ) Δ t \\ {z}_{n + 1} = {z}_{n} + {\dot{z}}_{n} Δ t = {z}_{n} + ( \vert {x}_{n} \vert - β {z}_{n} ) Δ t\end{matrix} .$$

The abovementioned differential equations of the Lorenz system or the modified Lorenz system may be approximated by using simple hardware circuits such as adders, bit shifters, flip-flops and/or multiplexers, allowing the chaos system 112 to be implementable in an integrated circuit (IC).

The post-processing circuit 114, which is coupled to the chaos system 112, may process the chaos signals Xₒᵤₜ, Yₒᵤₜ and Zₒᵤₜ to generate random signals u1-u3, respectively. The post-processing circuit 114 is configured to scramble the chaos signals Xₒᵤₜ, Yₒᵤₜ and Zₒᵤₜ to generate and output the random signals u1-u3 having higher randomness. In an embodiment, the post-processing circuit 114 may include several modulo operation circuits M1-M3, each performing post-processing on one of the chaos signals Xₒᵤₜ, Yₒᵤₜ and Zₒᵤₜ. The modulo operation circuits M1-M3 may take the fractional part of the chaos signals Xₒᵤₜ, Yₒᵤₜ and Zₒᵤₜ, and generate the random signals u1-u3 having random numbers based on the fractional part. The post-processing operations may be applied to enhance the randomness of the random signals u1-u3. In other embodiments, examples of the post-processing operations in the post-processing circuit 114 include, but not limited to, bit shift, bit reverse, and any appropriate logic operations, and these operations may be feasible in the IC.

In an embodiment, the modulo operation circuit M1, M2 or M3 may shift the integer part of the chaos signal Xₒᵤₜ, Yₒᵤₜ or Zₒᵤₜ to be added to the fractional part of the chaos signal Xₒᵤₜ, Yₒᵤₜ and Zₒᵤₜ as the least significant bits (LSBs), so as to generate a random number uniformly distributed between 0 and 1. For example, the chaos signal Xₒᵤₜ may be equal to (011000.001011011)_{b}, where the 6-bit integer part 011000 may be shifted to be the LSBs of the fractional part (by the modulo operation circuit M1), and the output random signal u1 will be (0.001011011011000)_{b}. In a similar manner, the modulo operation circuit M2 may convert the chaos signal Yₒᵤₜ into the random signal u2, and the modulo operation circuit M3 may convert the chaos signal Zₒᵤₜ into the random signal u3.

Since each of the random signals u1-u3 has a series of random bits, the random number generator 10 or a subsequent circuit may further combine random the signals u1-u3 (e.g., through parallel-to-serial conversion) to generate a random number sequence as its output.

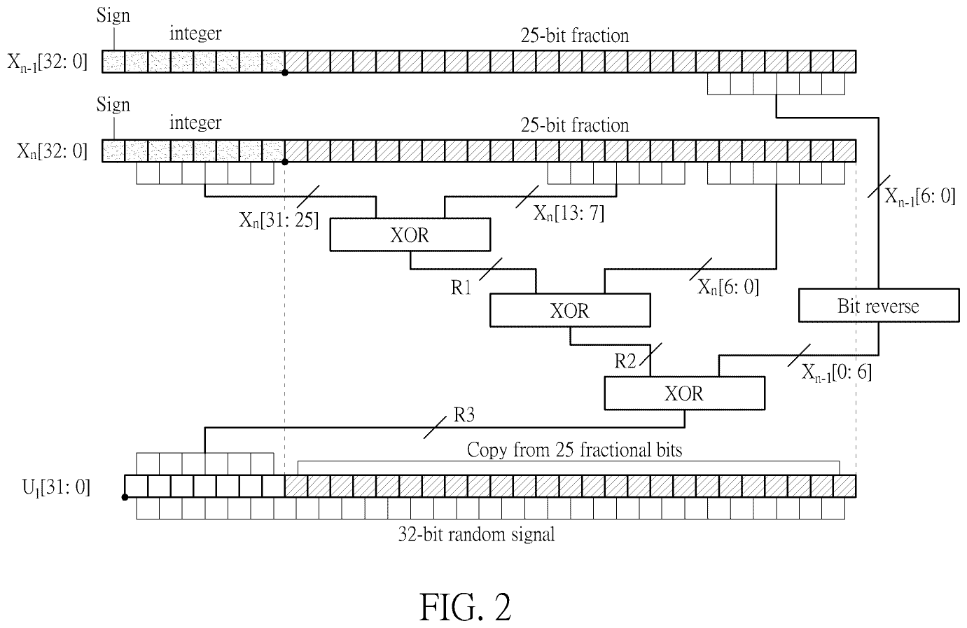

In another embodiment, the modulo operation circuit M1, M2 or M3 may apply logic operations to generate the random signal u1, u2 or u3, so as to enhance the randomness of the output random numbers. FIG. 2 illustrates an exemplary implementation of converting the chaos signal Xₒᵤₜ into the random signal u1 according to an embodiment of the present invention. As shown in FIG. 2, the chaos signal Xₒᵤₜ used to perform calculations may be a 33-bit signal (denoted by Xₙ[32:0], where the most significant bit (MSB) Xₙ is a sign bit), which is used to generate a 32-bit random signal u1 (denoted by U₁[31:0]). The bits Xₙ[31:25] are the integer part of the chaos signal Xₒᵤₜ, and the bits Xₙ[24:0] are the fractional part of the chaos signal Xₒᵤₜ.

The logic operations are as follows. First, take the 7-bit integer part Xₙ[31:25] to perform a bitwise exclusive-OR (XOR) operation with Xₙ[13:7], where Xₙ[13:7] are 7 bits excerpted from the fractional part, to generate a first operational result R1. The first operational result R1 is taken to perform a bitwise XOR operation with the LSBs Xₙ[6:0] to generate a second operational result R2. The second operational result R2 is further taken to perform a bitwise XOR operation with a reverse order of 7 LSBs of the previous chaos signal Xₒᵤₜ (denoted by Xₙ₋₁[32:0], of which the 7 LSBs are Xₙ₋₁[6:0], of which the bit order is reversed to be Xₙ₋₁[0:6]) to generate a third operational result R3. The third operational result R3 may be taken as 7 MSBs of the random signal u1 (i.e., U₁[31:25]), and the other 25 bits (i.e., U₁[24:0]) of the random signal u1 are copied from the original 25 fractional bits of the chaos signal Xₒᵤₜ, so as to generate the 32-bit random signal u1. Based on the multiple XOR operations, the randomness of the random signal u1 will be significantly enhanced.

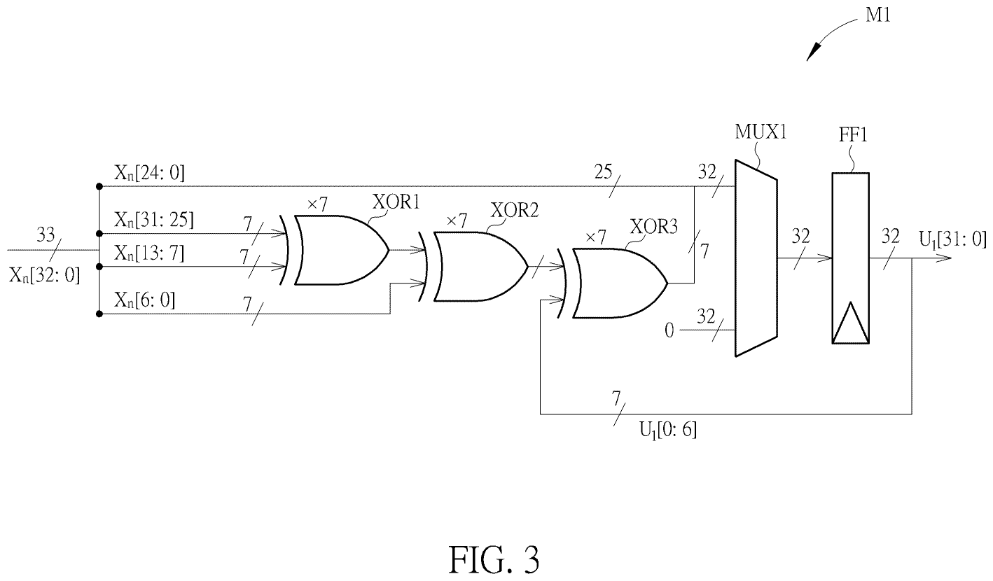

The corresponding circuit structure of the modulo operation circuit M1 for performing the above operations is shown in FIG. 3. As can be seen in FIG. 3, the modulo operation circuit M1 may be easily implemented by using simple logic circuits including several logic gates (i.e., XOR gates) XOR1-XOR3, a multiplexer MUX1 and a flip-flop FF1.

In a similar manner, the chaos signal Yₒᵤₜ may be applied to generate the random signal u2 by the modulo operation circuit M2, and the chaos signal Zₒᵤₜ may be applied to generate the random signal u3 by the modulo operation circuit M3.

In a first embodiment, the chaos system 112 applies the Lorenz system, which has parameters (σ, ρ, β)=(10, 28, 8/3) and is solved by using the Euler method. Each of the modulo operation circuits M1-M3 of the post-processing circuit 114 applies the abovementioned bit-shift scheme to add the integer part of the chaos signal Xₒᵤₜ, Yₒᵤₜ or Zₒᵤₜ as the LSBs to its fractional part. Under the implementations, the random numbers output by the random number generator 10, including the random signals u1-u3, can pass all the items of NIST-800-20 Test, which means that the random numbers have sufficient randomness. A simulation result indicates that the random numbers output by the random number generator 10 are uniformly distributed and highly autocorrelated. In addition, the random number generator 10 of the present invention may achieve a high throughput of 1.5 million samples per second (or equivalently 3 gigabits/sec), which is superior to any currently available random number generators.

In a second embodiment, the chaos system 112 applies the modified Lorenz system, which has parameters (σ, ρ, β)=(0.5, 50, 0.25) and is solved by using the Euler method. Each of the modulo operation circuits M1-M3 of the post-processing circuit 114 applies the abovementioned multiple XOR operations illustrated in FIG. 2. In addition, the perturbation signals P are received by the chaos system 112 with a predetermined cycle (e.g., as controlled by the control circuit 104). For example, a perturbation signal P may be inserted once in every 5 output cycles. Under the implementations, the random numbers output by the random number generator 10, including the random signals u1-u3, can also pass all the items of NIST-800-20 Test. A simulation result indicates that the random numbers are uniformly distributed and highly autocorrelated, and the random number generator 10 of the present invention may achieve an ultra-high throughput of 1.111 billion samples per second (or equivalently 35.5556 gigabits/sec), which is superior to the first embodiment.

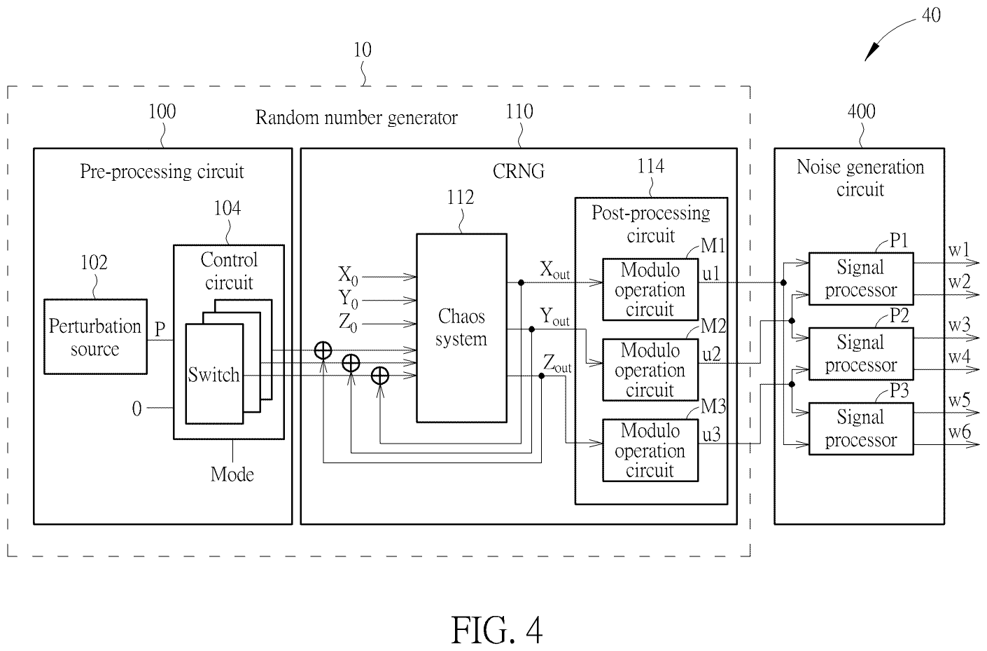

As mentioned above, in several embodiments of the present invention, the random number generator may further be integrated with a noise generation circuit to convert a series of random numbers having uniform distribution into noise signals having normal distribution. FIG. 4 is a schematic diagram of a noise generator 40 according to an embodiment of the present invention. The noise generator 40 includes the random number generator 10 shown in FIG. 1 coupled to a noise generation circuit 400. In FIG. 4, the structure of the random number generator 10 is the same as that shown in FIG. 1, and thus its components and related signals are denoted by the same symbols. The noise generation circuit 400 is coupled to the output terminals of the random number generator 10, and includes signal processors P1-P3 for receiving the random signals u1-u3, respectively. Since the noise generator 40 generates the noise outputs based on the random signals u1-u3 which are generated with a chaos system, the noise generator 40 may be regarded as a chaos noise generator.

In detail, the random number generator 10 may output the random signals u1-u3 to the noise generation circuit 400. By receiving the uniformly distributed random signals u1-u3, the noise generation circuit 400 may generate and output 6 normally distributed noise signals w1-w6. In the noise generation circuit 400, the signal processor P1 is configured to convert the random signals u1 and u2 into the noise signals w1 and w2, the signal processor P2 is configured to convert the random signals u2 and u3 into the noise signals w3 and w4, and the signal processor P3 is configured to convert the random signals u1 and u3 into the noise signals w5 and w6. An exemplary implementation of each of the signal processors P1-P3 is a Box-Muller processor, which applies the Box-Muller transform to convert uniformly distributed random variables into normally distributed random variables. The formulas of the Box-Muller transform are described below:

$${w}_{1} = \sqrt{- 2 \times ln ( u 1 )} cos ( 2 π u 2 ) ∼ N ( 0 , 1 ) ;$$

$${w}_{2} = \sqrt{- 2 \times ln ( u 1 )} sin ( 2 π u 2 ) ∼ N ( 0 , 1 ) ;$$

$${w}_{3} = \sqrt{- 2 \times ln ( u 2 )} cos ( 2 π u 3 ) ∼ N ( 0 , 1 ) ;$$

$${w}_{4} = \sqrt{- 2 \times ln ( u 2 )} sin ( 2 π u 3 ) ∼ N ( 0 , 1 ) ;$$

$${w}_{5} = \sqrt{- 2 \times ln ( u 3 )} cos ( 2 π u 1 ) ∼ N ( 0 , 1 ) ;$$

$${w}_{6} = \sqrt{- 2 \times ln ( u 3 )} sin ( 2 π u 1 ) ∼ N ( 0 , 1 ) .$$

Based on the above formulas, each Box-Muller processor is responsible to convert 2 input random variables into 2 output random variables. In this embodiment, the noise generation circuit 400 includes 3 Box-Muller processors P1-P3, which are arranged appropriately to generate 6 noise signals w1-w6 (with standard normal distribution) based on 3 random signals u1-u3 (with uniform distribution) received from the CRNG 110.

Note that the Box-Muller processors may also be implementable in an IC by using hardware circuits. For example, the cosine and sine functions may be realized by using the coordinate rotation digital computer (CORDIC) algorithm, and the natural logarithm and square root functions may be realized by using the hyperbolic CORDIC algorithm.

A simulation result for the noise generator 40 indicates that the output noise signals w1-w6 have standard normal distribution, and the noise signals w1-w6 still possess high randomness and high autocorrelation. Since the noise generation circuit 400 may convert 3 random signals u1-u3 into 6 noise signals w1-w6, the system throughput will be doubled.

Note that the present invention aims at providing a novel random number generator and noise generator implemented with a chaos system, to achieve excellent performance such as high randomness and high throughput. Those skilled in the art may make modifications and alterations accordingly. For example, in the above embodiments, a (modified) Lorenz system is applied to realize a 3-dimensional chaos system (i.e., X, Y and Z), which includes first-order differential equations to be solved by using the Euler method. In another embodiment, the chaos system may be a 1-dimensional system, 2-dimensional system, 4-dimensional system, or more, but not limited thereto. In addition, the method of solving the differential equations is not limited to the Euler method, and the differential equations to be solved may be in any order, which are not limited to those described in this disclosure. In addition, the post-processing schemes provided in the above embodiments are merely examples for illustrations. In another embodiment, in the post-processing circuit, several circuit operations such as the bit shift, bit reverse, and/or any logic operations may be combined in any appropriate manners to scramble the chaos signals and enhance the randomness of the output random signals.

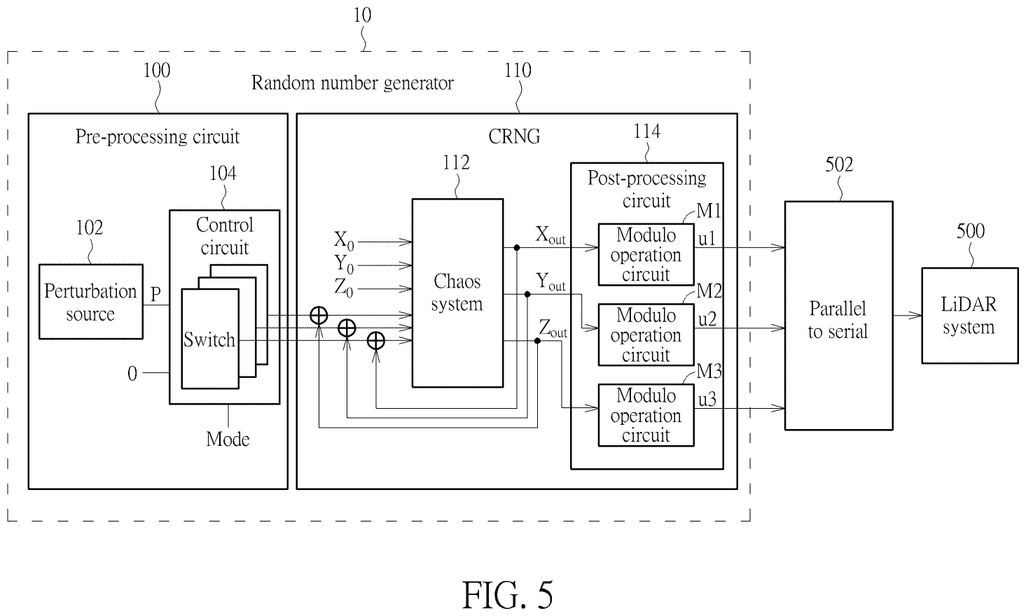

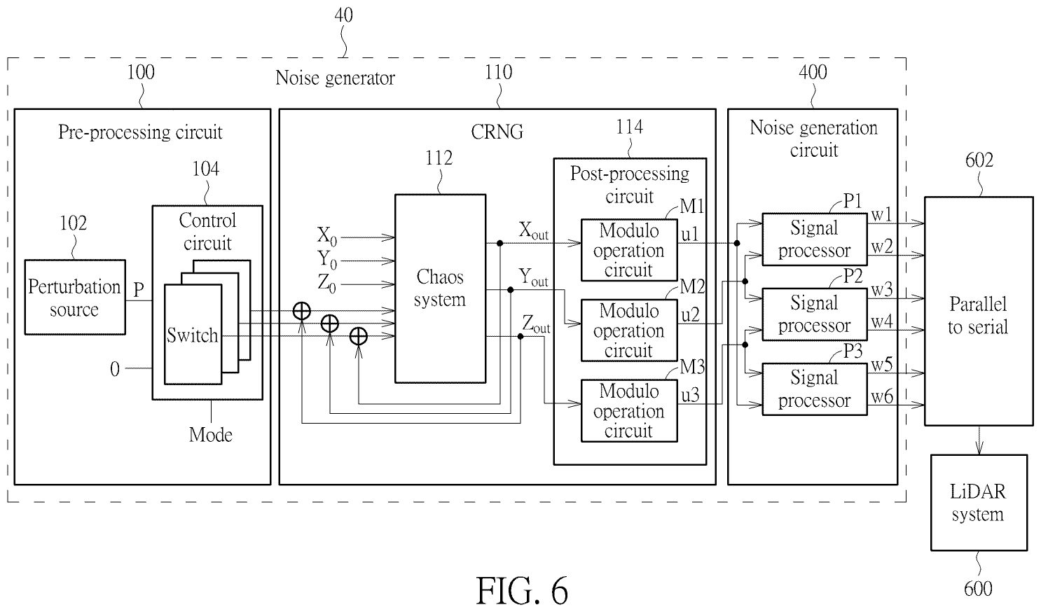

In several embodiments, the random number generator or noise generator of the present invention may be applicable to an optical detector, where the random signals of the random number generator or the noise signals of the noise generator may be output to the optical detector to enhance its anti-interference capability and recognizability. For example, in an embodiment, the random number generator or noise generator may be used in a light detection and ranging (LiDAR) system. The LiDAR is a remote sensing scheme used to detect an object and determine the distance of the object. The random numbers may be applied as an identifier to be carried on the light signals output by the LiDAR transmitter. The identifier should be unique and recognizable by the LiDAR receiver, so that it will not be easily interfered with by environmental noises, or interfered with by the signals generated from any other detector or sensing systems. Therefore, the random signals or noise signals having high randomness and high autocorrelation are appropriate to achieve the purpose of anti-interference. In an embodiment, the random signals (e.g., u1-u3) output by the random number generator (such as the random number generator 10 shown in FIG. 1) are applied to a LiDAR system 500, as shown in FIG. 5. In another embodiment, the noise signals (e.g., w1-w6) output by the noise generator (such as the noise generator 40 shown in FIG. 4) are applied to a LiDAR system 600, as shown in FIG. 6.

As shown in FIGS. 5 and 6, a parallel-to-serial converter 502 or 602 may be applied to convert the random signals u1-u3 or the noise signals w1-w6 into a random number sequence, which is then output to the LiDAR system 500 or 600. The parallel-to-serial converter 502 or 602 may arrange the input signals in any appropriate manner, and its structure and implementation are familiar to those skilled in the art and will not be detailed herein.

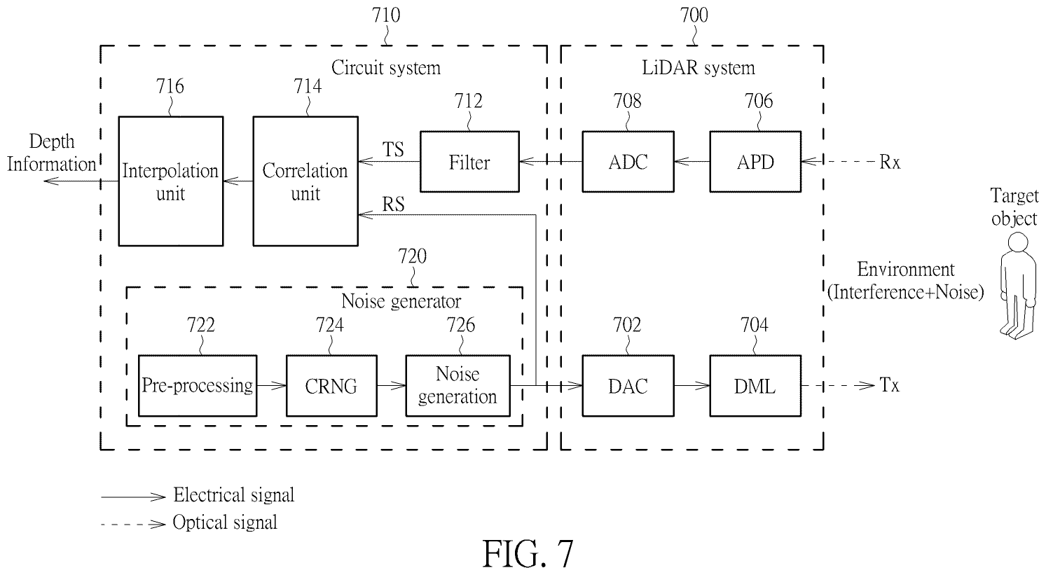

FIG. 7 illustrates a detailed implementation for realizing the application of a LiDAR system 700. As shown in FIG. 7, the LiDAR system 700 includes a digital-to-analog converter (DAC) 702 and a directly modulated laser (DML) 704 at the transmitter (Tx) side and includes a photodiode (APD) 706 and an ADC 708 at the receiver (Rx) side. The LiDAR system 700 may be coupled to a circuit system 710, to receive a random signal or a noise signal from the circuit system 710. The circuit system 710 may be implemented on a field programmable gate array (FPGA), where a noise generator 720 may be implemented in an FPGA IC to be coupled to the LiDAR system 700. The noise generator 720, which includes a pre-processing circuit 722, a CRNG 724 and a noise generation circuit 726 as similar to the structure of the noise generator 40 shown in FIG. 4, may provide noise signals for the LiDAR system 700. Alternatively, the noise generator 720 may be replaced by a random number generator, such as the random number generator 10 shown in FIG. 1, which may provide random signals for the LiDAR system 700. The circuit system 710 may further include a filter 712 (which may be a Chebyshev filter or any other appropriate type of filter), a correlation unit 714 and an interpolation unit 716.

The noise signals (or random signals) received by the LiDAR system 700 may undergo the DAC 702 to be converted into an analog form. The DML 704 may convert electrical signals having the dedicated noise signals into optical signals and then output the optical signals. The optical signals will be reflected by a target object and then received by the photodiode 706, where the environmental interferences and/or noises may be received along with the reflected signals. The reflected signals are then processed by the ADC 708 and the filter 712, to generate a target signal TS corresponding to the target object. More specifically, the photodiode 706 may convert the received optical signals into electrical signals, which is converted into a digital form by the ADC 708. The filter 712 then filters out unnecessary frequency components in the electrical signals. Subsequently, the correlation unit 714 may use a cross-correlation method to remove the environmental interferences and/or noises in the target signal TS with reference to a reference signal RS received from the noise generator 720. The cross-correlation result may further be processed by the interpolation unit 716 to obtain depth information that indicates the object distance.

In an embodiment, the circuit system 710 of the LiDAR system 700 may calculate the time difference from outputting the light signals to receiving the reflected signals, so as to determine the distance information. Since the optical signals carry the random noise signals generated by the noise generator 720 as a unique identifier, the receiver will not wrongly detect another signal, or the received reflected signals will not be easily interfered with by other signals. The reflected target signal TS can be recognized correctly by using the cross-correlation method with the reference signal RS.

As mentioned above, the random number generator of the present invention applies a chaos system receiving randomized/perturbed initial signals. Since the chaos system is sensitive to its initial signals, the perturbation of the initial signals ensures that the output random numbers have high autocorrelation, which can achieve high anti-interference capability.

A simulation result shows that the LiDAR system using the noise generator (or the random number generator) of the present invention can achieve a low peak sidelobe level (PSL) and high standard deviation of PSL (PSL_{std}). The parameters PSL and PSL_{std} are usually used to evaluate the performance of the LiDAR system. The PSL is a value representing the peak sidelobe level relative to the peak value of cross-correlation, and a lower PSL indicates a higher anti-interference capability. The PSL_{std} is the peak value of cross-correlation relative to the noise level, and a higher PSL_{std} indicates a higher anti-interference capability. The simulation result also shows that the LiDAR system using the noise generator (or the random number generator) of the present invention has a high precision and low error rate.

Based on the simulation for the LiDAR system, the usage of the noise signals appears to have higher performance than the random numbers over the PSL, PSL_{std}, precision, and error rate. In other words, the noise signals converted from the random signals will have even higher autocorrelation and higher randomness, so as to achieve a better anti-interference capability.

Note that the LiDAR system is one of various applications of the random number generator or the noise generator of the present invention. In various embodiments, the random number generator or the noise generator of the present invention may be used in coding, cryptography, and/or security applications.

To sum up, the present invention provides a novel random number generator and a noise generator based on a chaos system. In the random number generator, a pre-processing circuit may be applied to generate a perturbation signal, to disturb the initial value and/or the iteration process of the chaos system, so as to achieve higher randomness. The perturbation signal may be generated by using an ADC to sample environmental noises. In addition, a post-processing circuit may be applied to modify the chaos signals to generate random signals having uniform distribution. The post-processing operation may include, but not limited to, bit shift, bit reverse, any logic operations, and/or their combinations. In an embodiment, the chaos system may be a Lorenz system or modified Lorenz system, which has several differential equations to be solved by using the Euler method, in order to generate chaos output signals.

In addition, the random number generator of the present invention may be integrated with a noise generation circuit to realize the noise generator. The noise generation circuit may convert the uniformly distributed random signals into normally distributed noise signals. In an exemplary embodiment, the noise generation circuit may be implemented with several Box-Muller processors for converting the random signals into the noise signals.

The random number generator and the noise generator of the present invention may achieve high performance due to their high randomness, high autocorrelation and high unpredictability achieved by the chaos system with input perturbations. Using the Euler method to solve the first-order differential equations has low complexity and thus may be implemented in an IC with low circuit costs, and may also achieve high throughput. Using modulo operations in the post-processing circuit may also achieve low costs and high throughput. Multiple Box-Muller processors applied in the noise generation circuit may further enhance the throughput, e.g., 3 random signals may be converted into 6 noise signals to double the throughput. The overall system may be realized by using digital circuits and thus may be implemented in an IC such as the FPGA. In addition, the digital circuits may further have the benefits of easy transitions between different manufacturing processes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A random number generator, comprising:
a pre-processing circuit, comprising:
a perturbation source; and
a control circuit, coupled to the perturbation source; and
a chaos random number generator (CRNG), coupled to the pre-processing circuit, comprising:
a chaos system; and
a post-processing circuit, coupled to the chaos system.

2. The random number generator of claim 1, wherein the pre-processing circuit outputs a perturbation signal to be used as an initial value of the CRNG or to modify an initial value of the CRNG.

3. The random number generator of claim 2, wherein the perturbation signal is generated from an environmental noise.

4. The random number generator of claim 2, wherein the chaos system is configured to generate a chaos signal according to the initial value.

5. The random number generator of claim 1, wherein the chaos system is a Euler-based chaos system.

6. The random number generator of claim 1, wherein the chaos system uses a Euler method to solve a differential equation of a Lorenz system or a modified Lorenz system.

7. The random number generator of claim 1, wherein the post-processing circuit is configured to scramble a chaos signal of the chaos system.

8. The random number generator of claim 1, wherein the post-processing circuit comprises a modulo operation circuit.

9. The random number generator of claim 8, wherein the modulo operation circuit generates a random signal according to a fractional part of a chaos signal of the chaos system.

10. The random number generator of claim 1, wherein the random number generator is coupled to a noise generation circuit.

11. The random number generator of claim 10, wherein the random number generator is configured to output a random signal to the noise generation circuit.

12. The random number generator of claim 1, wherein the random number generator is configured to output a random signal to an optical detector.

13. A noise generator, comprising:
a random number generator, comprising:
a pre-processing circuit, comprising:
a perturbation source; and
a control circuit, coupled to the perturbation source; and
a chaos random number generator (CRNG), coupled to the pre-processing circuit, comprising:
a chaos system; and
a post-processing circuit, coupled to the chaos system; and
a noise generation circuit, coupled to the random number generator.

14. The noise generator of claim 13, wherein the pre-processing circuit outputs a perturbation signal to be used as an initial value of the CRNG or to modify an initial value of the CRNG.

15. The noise generator of claim 14, wherein the perturbation signal is generated from an environmental noise.

16. The noise generator of claim 14, wherein the chaos system is configured to generate a chaos signal according to the initial value.

17. The noise generator of claim 13, wherein the chaos system is a Euler-based chaos system.

18. The noise generator of claim 13, wherein the chaos system uses a Euler method to solve a differential equation of a Lorenz system or a modified Lorenz system.

19. The noise generator of claim 13, wherein the post-processing circuit is configured to scramble a chaos signal of the chaos system.

20. The noise generator of claim 13, wherein the post-processing circuit comprises a modulo operation circuit.

21. The noise generator of claim 20, wherein the modulo operation circuit generates a random signal according to a fractional part of a chaos signal of the chaos system.

22. The noise generator of claim 13, wherein the random number generator is configured to output a random signal to the noise generation circuit.

23. The noise generator of claim 13, wherein the noise generation circuit is configured to convert a uniformly distributed random signal into a normally distributed noise signal.

24. The noise generator of claim 13, wherein the noise generator is configured to output a noise signal to an optical detector.
